(19) United States
(12) Patent Application Publication
(10) Pub. No.: US 2022/0343888 A1
(43) Pub. Date: Oct. 27, 2022

(54) AUDIO DEVICE WITH ACOUSTIC ECHO CANCELLATION

(71) Applicant: Tymphany Worldwide Enterprises Limited, Grand Cayman (KY)

(72) Inventor: Dimitrios GRIMANIS, Shenzhen (CN)

(21) Appl. No.: 17/725,886

(22) Filed: Apr. 21, 2022

Related U.S. Application Data
(60) Provisional application No. 63/177,576, filed on Apr. 21, 2021.

(51) Int. Cl. G10K 11/178; H04R 1/02; H04R 1/40; H04R 3/00

(52) U.S. Cl. CPC G10K 11/17823; G10K 11/17873; H04R 1/025; G10K 11/17854; H04R 1/406; H04R 3/005; G10K 2210/505; G10K 2210/3027; G10K 2210/108; G10K 2210/3035; G10K 2210/3028

(57) ABSTRACT

An audio device with acoustic echo cancellation includes a device cabinet having a cabinet interior; a first open back driver receiving a first open driver input from an audio source; a second open back driver receiving a second open driver input from the audio source, wherein the first open back driver and the second open back driver are acoustically coupled to the cabinet interior; a reference microphone located in the cabinet interior to record a reference microphone signal based on sound emitted within the cabinet interior by the first open back driver and the second open back driver based on the first open driver input and the second open driver input, respectively; and an acoustic echo cancellation block subtracting a representation of the reference microphone signal from a representation of a set of input microphone signals to provide an echo-cancelled output.

### CROSS REFERENCE TO RELATED APPLICATIONS

This application claims priority of U.S. Provisional Application No. 63/177,576 filed on Apr. 21, 2021 under 35 U.S.C. § 119(e), the entire contents of all of which are hereby incorporated by reference.

### FIELD OF THE INVENTION

The present invention relates to audio devices with acoustic echo cancellation and methods for acoustic echo cancellation.

### BACKGROUND OF THE INVENTION

The aim of acoustic echo cancellation is to remove sound of a nearby speaker from the signal recorded by a microphone. Such processing may for example be performed in telecommunication, or for voice-enabled products.

Acoustic echo cancellation is challenging to implement for audio devices with multiple independent audio channels for multiple drivers. Typical conventional acoustic echo cancellation solutions are limited to remove echo from inputs of microphones based on one or two independent reference channels. Hence, processing in systems with two channels, three channels, or more than three channels may be challenging or expensive to implement.

U.S. Pat. No. 9,978,387 B1 discloses an audio device having an output speaker that produces audio within the environment of a user and one or more input microphones that capture speech and other sounds from the user environment. The audio device may use acoustic echo cancellation (AEC) to suppress echoed components of the speaker output that may be present in audio captured by the input microphones. The AEC may be implemented using an adaptive filter that estimates echoing based on an output reference signal. The output reference signal may be generated by a reference microphone placed near the speaker of the audio device.

### SUMMARY OF THE INVENTION

The inventors have identified the above-mentioned problems and challenges related to acoustic echo cancellations and subsequently made the below-described invention, which may provide improved related methods and audio devices.

The invention relates to audio devices with acoustic echo cancellation and methods for acoustic echo cancellation as represented by the claims.

By having a reference microphone signal based on sound emitted by several drivers within a device cabinet, it is possible to reduce the number of reference signals needed for acoustic echo cancellation, which is advantageous. This may in principle permit conventional and relatively simple acoustic echo cancellation methods to be implemented for devices with any number of drivers.

Furthermore, a reference microphone may additionally record nonlinearities of one or more drivers and, consequently, such nonlinearities will also be included in the acoustic echo cancellation, which is advantageous.

For embodiments with a closed back driver, the input to such a driver may further be used for the acoustic echo cancellation, thus permitting the advantages offered by an internal reference microphone to be implemented in systems which both open back drivers and closed back drivers, which is advantageous.

In contrast to the U.S. Pat. No. 9,978,387 B1, embodiments of the invention have both a first open back driver and a second open back driver which are acoustically coupled to a cabinet interior, such that a reference microphone located in the cabinet interior records a reference microphone signal based on sound emitted within said cabinet interior by the first open back driver and the second open back driver based on a first open driver input and a second open driver input, respectively.

### BRIEF DESCRIPTION OF THE DRAWINGS

Various embodiments of the invention will in the following be described with reference to the drawings wherein:

FIG. 1 illustrates an audio device of the invention in which a reference microphone records sound emitted within the cabinet interior from two open back drivers;

FIG. 2 illustrates another audio device of the invention in which an acoustic echo cancellation block subtracts a representation of a reference microphone signal and a representation of a closed driver input from a representation of an input microphone signal;

FIG. 3 illustrates a method for acoustic echo cancellation according to an embodiment of the invention;

FIG. 4 illustrates exterior and interior sound of open back drivers and a closed back driver;

FIG. 5 illustrated external sound of an external sound source;

FIG. 6 illustrates another embodiment of the invention; and

FIG. 7 illustrates an exemplary acoustic echo cancellation block.

### DETAILED DESCRIPTION

In the following, various concepts of the invention are presented without reference to particular embodiments.

An audio source may be understood as a source of audio signals. Multiple audio signals of an audio source may for example correspond to different audio channels stemming from a main audio signal. For example, different frequency content of a master audio signal is distributed by a crossover circuit to two or more audio signals/audio channels, which may then be supplied to different drivers. Different audio signals may also correspond to channels of stereo or surround sound.

Examples of an audio source is a digital signal processor, a digital storage, an audio plug, and a wireless audio receiver (e.g., Bluetooth, radio receiver, Wi-Fi), but the invention is not limited to these examples. An audio source may optionally receive audio from an external audio source, or alternatively, an internal audio storage.

A device cabinet is an enclosure in which speaker drivers and associated electronic hardware are mounted. Alternatively, a device cabinet may be referred to as a loudspeaker enclosure. Embodiments of the invention are not restricted to any particular shape or type of device cabinet. They may, thus, for example, be fully closed, be vented/ported, and/or comprise horns or waveguides.

A device cabinet has a cabinet interior and a cabinet exterior. The cabinet interior may be understood as a volume of space within the outer boundary of the device cabinet. The cabinet exterior may similarly be understood as a volume of space outside the outer boundary of the device cabinet. The cabinet interior may be at least partly acoustically decoupled from the cabinet exterior.

An open back driver may be understood as a speaker driver, which has an open back. An open back driver is, thus, different from a closed back driver, which is a speaker driver with a closed or sealed back in a rearward direction of the diaphragm.

Whether a certain driver is open or closed may for example affect interaction of sound waves from front and back, frequency response of the driver, damping, and protection of the driver from the environment. Typically, tweeters are closed, and woofers/sub-woofers are open. However, the invention is not restricted to particular types of closed drivers and open drivers.

In some embodiments of the invention with a closed back driver, the closed back driver may typically be at least partly acoustically decoupled from the cabinet interior. Such a closed back driver emits sound primarily in its forward-facing direction, out into the cabinet exterior. In contrast, in embodiments of the invention, any open back drivers are typically acoustically coupled to the cabinet interior. Such an open back driver may, thus, emit sound both in its forward-facing direction into the cabinet exterior, and in its rearward direction into the cabinet interior. Thus, typically, sound of an open back driver relatively to sound of a closed back driver is larger in said cabinet interior than in said cabinet exterior.

A reference microphone may be understood as a microphone located within the device interior for recording sound emitted in a rearward direction by one or more open back drivers for the purpose of using this sound for acoustic echo cancellation. A reference microphone may be any type of microphone.

An input microphone may be understood a microphone for recording sound onto which acoustic echo cancellation is to be applied. This sound may, thus, typically both comprise sound content originating from drivers of the audio device, as well as sound content from an external sound source, e.g., a person/user of the audio device. Ideally, the embodiments of the invention may be capable of at least partly reducing the relative sound content originating from drivers of the audio device, such that sound content from the external sound source can be processed further with reduced undesired sound from the drivers. This may for example permit improved telecommunication or improved voice enabling of the audio device.

A reference microphone may typically be primarily coupled to the device interior. In other words, it may have a stronger acoustic coupling with the device interior than with the device exterior. In contrast, an input microphone may typically be primarily coupled to the device exterior. Or, in other words, it may have a stronger acoustic coupling with the device exterior than with the device interior.

A set of input microphone may be one input microphone or several input microphones. Similarly, a set of input microphone signals may be understood a one input microphone signal or several input microphone signals. Typically, each of the signals of the set of input microphone signals corresponds to sound recorded by each of the microphones of the set of input microphones. For example, a set of three input microphone each record a microphone signal resulting in a set of three input microphone signals.

In some embodiments, one or more input microphones are integrated in the audio device. In other embodiments, the audio device may receive one or more input microphone signals from one or more corresponding external microphones.

Typically, for embodiments of the invention, the set of microphone signals comprises at least sound emitted into the device exterior by drivers of the audio device.

An acoustic echo cancellation block may be understood as a block configured to perform acoustic echo cancellation. It may for example be a stand-alone circuit, e.g., embedded on a chip, or it may be integrated in a processor such as a digital signal processor. An acoustic echo cancellation block may further be based on commercially available acoustic echo cancellation solutions. Typically, an acoustic echo cancellation block requires at least an input from a microphone, and a reference input, from which it is able to establish an echo-cancelled output, by removing representation of the reference input from the input of the microphone. Thus, an acoustic echo cancellation block of an audio device may then ensure that the relative content of sound originating from drivers of the audio device is lower in the echo-cancelled output, than in its input microphone. For acoustic echo cancellation, undesired sound may not necessarily be fully removed/cancelled/suppressed in the echo-cancelled output, but it should preferably be at least partially reduced.

An acoustic echo cancellation block may have several reference inputs, and/or other additional inputs, such as a representation of user-controlled audio volume.

Embodiments of the invention may not relay on exactly subtracting a reference microphone signal from an input microphone signal to provide an echo-cancelled output. Instead, embodiments may rely on subtracting a representation of the reference microphone signal from a representation of a set of input microphone signals to provide the echo-cancelled output. A representation of a signal may for example involve a change in timing/delay, change in volume, filtering, or other relevant processing in comparison with the signal itself. A representation of a signal may also just be the signal. Typically, for acoustic echo cancellation, processing (e.g., delay and/or change in volume) of a reference signal may be necessary to optimize the cancellation of undesired sound. Such processing may be performed by the acoustic echo cancellation block. Further, such processing may be dynamically varied to adjust the cancellation to a given sound content of a given acoustic environment.

Embodiments of the invention are not restricted to a particular type of acoustic echo cancellation, or a particular acoustic echo cancellation block. Embodiments may for example use conventional, commercially available acoustic echo cancellation solution, acoustic echo cancellation solutions implemented in a processor such as a digital signal processor, acoustic echo cancellation solutions particularly tailored for processing a reference microphone input, other acoustic echo cancellation solutions, or any combination thereof.

An echo-cancelled output may be used in further processing. For example, if the audio device is a voice-enabled audio device, it may process the echo-cancelled output to identify voice commands such as “turn off/on”, “increase volume”, “change music” or oral requests of performing telecommunication or accessing the internet. Identification of such commands may then activate a corresponding function of the audio device. A function may thus for example correspond to changing an audio setting (audio on/off, volume up/down, etc.) of the audio device.

An echo-cancelled output (or a representation thereof) may also be transmitted as a part of telecommunication, e.g., if the audio device is a telecommunication device such as a conference audio device.

In case of several input microphone signals, these may be processed/combined into a single signal, which is then a representation of the set of input microphone signals prior to being supplied to the acoustic echo cancellation block. In some embodiments, several input microphone signals are supplied individually to the acoustic echo cancellation block, which then subtracts at least representations of the reference microphone signal from these individual input microphone signals. Embodiments of the invention are not restricted to a particular number of input microphone signals being supplied to the acoustic echo cancellation block.

In the following, various concepts of the invention are presented with reference to the figures.

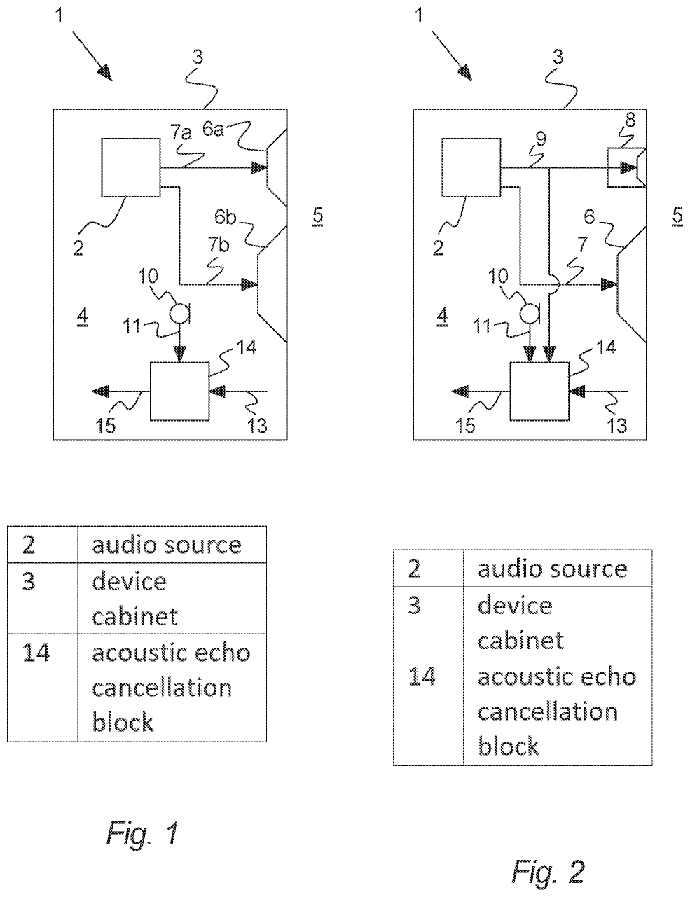

FIG. 1 illustrates an audio device 1 of the invention in which a reference microphone 10 records sound emitted within the cabinet interior 4 from two open back drivers 6a, 6b.

The audio device 1 has a device cabinet 3 in which drivers 6a, 6b are mounted and other electronics are integrated. The device cabinet 3 outlines a cabinet interior 4 and a cabinet exterior 5. The cabinet interior 4 is the internal enclosure of the device cabinet. The cabinet exterior 5 is the surrounding environment of the audio device 1.

The particular embodiment illustrated in FIG. 1 comprises a first open back driver 6a and a second open back driver 6b. Such drivers may for example be a full range driver and a woofer. The first open back driver 6a receives a first open driver input 7a, and the second open back diver 6b receives a second open driver input 7b. These inputs are audio signals, which drive the drivers such that they generate audible sound.

The first and second open driver inputs 7a, 7b are provided by an audio source 2. In this embodiment, the audio source 2 establishes the separate first and second open driver inputs 7a, 7b based on external audio input received wirelessly by the audio device 1. Further, in this embodiment, the audio source implements that only low frequency content is provided to the second open back driver 6b, since it is a woofer.

As the first and second open driver inputs 7a, 7b are provided to the first and second open back drivers 6a, 6b, the drivers reproduce the content of the inputs as sound. Since the drivers are open back drivers, they to not only emit sound in a forward direction to the cabinet exterior 5, but they also emit sound in a backward direction into the cabinet interior 4.

In the cabinet interior 4, a reference microphone 10 is located, which records a reference microphone signal 11 based on the sound emitted within the cabinet interior 4 by the first open back driver 6a and the second open back driver 6b. The reference microphone signal is then provided to an acoustic echo cancellation block 14.

The acoustic echo cancellation block 14 further receives an input microphone signal 13. In this particular embodiment, the input microphone signal 13 is recorded by an external input microphone (not shown), which is external from the audio device 1. The external input microphone records the input microphone signal 13 primarily from the loudspeaker exterior 5. Thus, the input microphone signal 13 is based on sound emitted to the device exterior 5 by the first open back driver 6a and the second open back driver 6b. Further, the input microphone signal may further comprise content of an external sound form an external sound source (not shown). The external sound source may for example be a user, who issues verbal communication to the audio device 1.

The acoustic echo cancellation block 14, which receives the input microphone signal 13 and the reference microphone signal 11, subtracts the reference microphone signal 11 from the input microphone signal 13 to provide an echo-cancelled signal 15. In some embodiments of the invention, the input signals 11, 13 of the acoustic echo cancellation block 14 are subjected to audio processing prior to the subtraction, but in this exemplary embodiment, the reference microphone signal 11 is simple subtracted from the input microphone signal 13.

As a consequence of the subtraction, relative audio content originating from the drivers 6a, 6b is reduced in the echo-cancelled output 15, relatively to in the input microphone signal 13.

Thus, whenever a user speaks near the audio device 1, audio content from the user is simply passed through the acoustic echo cancellation block 14, whereas sound from the drivers 6a, 6b is reduced. In other words, the acoustic echo cancellation block 14 has reduced acoustic echo. Particularly, this reduction has been performed in a multi-channel audio system (two drivers with separate inputs), using only one reference input to the acoustic echo cancellation block 14. Further, any non-linearities in the audio reproduction of the drivers 6a, 6b have been accounted for due to the reference microphone 10 picking up these nonlinearities.

FIG. 2 illustrates another audio device 1 of the invention in which an acoustic echo cancellation block 14 subtracts a representation of a reference microphone signal 11 and a representation of a closed driver input 9 from a representation of an input microphone signal 13.

In comparison with the embodiment illustrated in FIG. 1, the embodiment illustrated in FIG. 2 has several of the same features. However, instead of having two open back drivers, the embodiment of FIG. 2 has an open back driver 6, and a closed back driver 8. The closed back driver 8 is a tweeter, and the open back driver 6 is a full-range driver.

The open back driver 6 receives an open driver input 7, and the closed back driver 8 receives a closed driver input 9. These two separate inputs 7, 9 are provided by an audio source 2.

The open back driver 6 emits sound based on the open driver input 7 in both a forward direction into the cabinet exterior 5 and a backward/rearward direction into the cabinet interior 4. However, the closed back driver primarily emits sound in a forward direction into the cabinet exterior 5. The closed back of the driver 8 ensures that sound, which would otherwise enter the cabinet interior 4 is substantially restricted from doing so.

The reference microphone 10 records a reference microphone signal 13 based on the sound emitted within the cabinet interior 4 by the open back driver 6. The reference microphone signal 13 is provided to the acoustic echo cancellation block 14. Furthermore, the closed driver input 9 is provided to the acoustic echo cancellation block 14.

An input microphone signal 13 is also provided to the acoustic echo cancelation block. The input microphone signal 13 primarily records sound from the cabinet exterior 5. It, thus, records sound emitted by the open back driver 6, the closed back driver 8, as well as any sound form an external sound source.

The acoustic echo cancellation block 14 subtracts the reference microphone signal 11 and the closed driver input 9 from the input microphone signal 13 and to establish an echo-cancelled output 15. Thus, an echo-cancelled output 15 has been established by a multi-channel audio device 1 with a combination of closed back speakers 8 and open back speakers 6. Particularly, non-linearities of the open back speaker 6 may have been at least partly accounted for in the echo cancellations due to the reference microphone 10, while also performing acoustic echo cancellation for a driver 8, which does not emit substantial sound to the location of the reference microphone 10 located in the device interior 4.

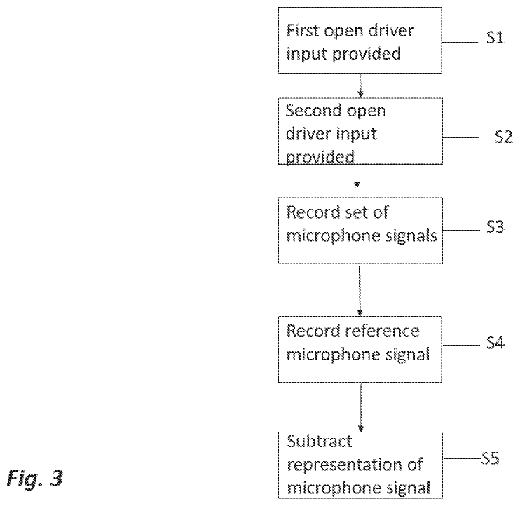

FIG. 3 illustrates a method for acoustic echo cancellation according to an embodiment of the invention.

In a first step S1 of the method, a first open driver input is provided to a first open back driver of an audio device to simultaneously emit sound within a cabinet interior and to a cabinet exterior of a device cabinet of the audio device.

In a next step S2 of the method, a second open driver input is provided to a second open back driver of the audio device to simultaneously emit sound within the cabinet interior and the cabinet exterior.

In a next step S3 of the method, a set of input microphone signals are recorded using a set of input microphones acoustically coupled to the cabinet exterior. Content of the input microphone signals may, for example, be based on sound emitted by the first and second open back drivers into the cabinet exterior, as well as external sound from an external sound source.

In a next step S4 of the method, a reference microphone signal is recorded using a reference microphone located in the cabinet interior. Content of the reference microphone signal may for example be based on sound emitted by the first and second open back drivers into the cabinet interior.

In a next step S5 of the method, a representation of the reference microphone signal is subtracted from a representation of the set of input microphone signals to provide an echo-cancelled output.

Embodiments of the invention are not restricted to a particular sequence of performing the steps. Typically, most of the steps are performed continuously in parallel.

Further, methods according to the invention may comprise further steps, for example processing the echo-cancelled output to active a function of the audio device. Or telecommunicating the echo-cancelled output.

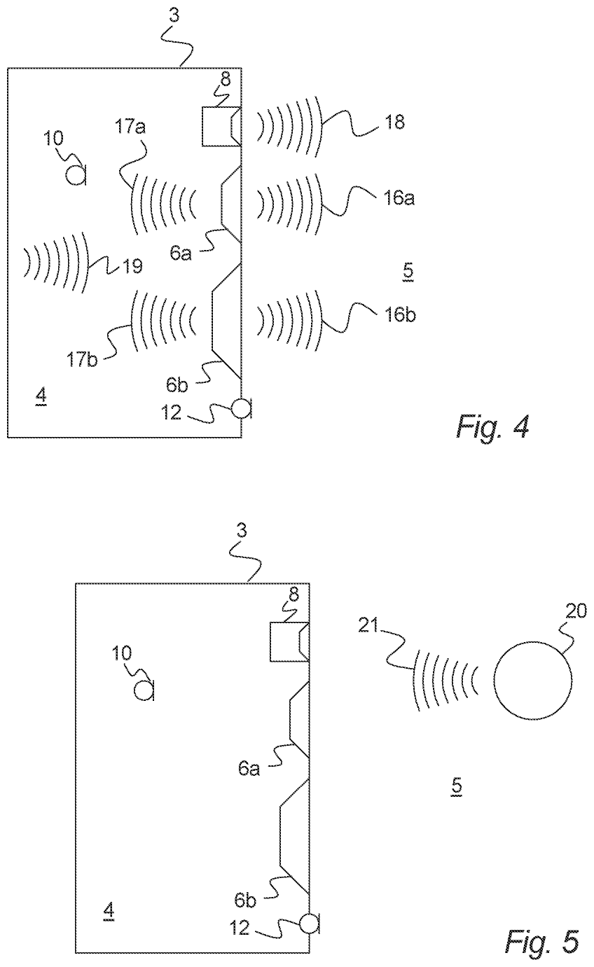

FIG. 4 illustrates exterior and interior sound of open back drivers 6a, 6b and a closed back driver 8.

The illustration shows a device cabinet 3, a closed back driver 8, two open back drivers 6a, 6b, a reference microphone, and an input microphone 12. In addition, the illustration shows exterior sound 16a, 16b, 18, interior sound 17a, 17b, and interior sound reflection 19.

Each of the three drivers 6a, 6b, 8 emits sound. The first open back driver 6a generates exterior sound 16a in the cabinet exterior 5 and interior sound 17a in the cabinet interior 4. Similarly, the second open back driver 6b also generates exterior sound 16b in the cabinet exterior 5 and interior sound 17b in the cabinet interior 4. The closed back driver 8 generates exterior sound 18 in the cabinet exterior 5.

Since the interior sound 17a, 17b is emitted in an enclosure, this sound is reflected to generate an interior sound reflection 19. Any open back driver 6a, 6b may contribute to the establishment of the interior sound reflection 19. Such a reflection 19 may interfere with the originally emitted interior sounds 17a, 17b and may establish a standing wave pattern. As a consequence of the sound reflections, the reference microphone 10 measures a different sound pressure level than if no reflections occurred. The exterior sound 16a, 16b, 18, which the input microphone 12 measures, has minimal content from the interior sound reflection 19. If the reference microphone signal recorded by the reference microphone 10 is used to remove content of exterior sound 16a, 16b, 18 in the input microphone signal recorded by the input microphone 12, then the interior sound reflection 19 may add distortions to an echo-cancelled signal after the subtraction of the reference microphone signal from the input microphone signal. Such distortions are undesirable. Hence it is advantageous to compensate for the recorded interior sound reflection 19.

Compensation for the recorded interior sound reflection 19 may for example be realized by insertion of a transfer function of the reflected microphone signal prior to the subtraction of the reference microphone signal from the input microphone signal. Such a transfer function may be implemented in practice by a digital signal processor, a filter, or other processing means. A model which at least partly predicts and/or compensates for the influence of reflections on the measured reference microphone signal may be referred to as an acoustic prediction model.

In an example of calibration and implementation of an acoustic prediction model, one or more of the drivers emit a white noise signal which is recorded by the reference microphone 10 at its position in the device cabinet 3. The difference between the emitted and the recorded signal is indicative of the transfer function which should be compensated. An appropriate finite impulse response (FIR) filter is then chosen and implemented between the reference microphone and an acoustic echo cancellation block.

FIG. 4 further illustrates the relative magnitude of sounds which the reference microphone 10 and the input microphone 12 records. Such relative magnitudes may be used as a characterization the topology of an audio device and its components.

In this example, sound content from the first open back driver 6a relatively to sound content from the closed back driver 8 is larger in the reference microphone signal than in the input microphone signal. Similarly, sound content from the second open back driver 6b relatively to sound content from the closed back driver 8 is larger in the reference microphone signal than in the input microphone signal. This occurs since the reference microphone 10 is primarily acoustically coupled to the cabinet interior 4, whereas the input microphone is primarily acoustically coupled to the cabinet exterior 5.

Further in this example, sound content from the interior sound reflection 19 relatively to sound content from the closed back driver is larger in the reference microphone signal than in the input microphone signal.

FIG. 5 illustrated external sound 21 of an external sound source 20. Further sound may be present as illustrated in FIG. 4, but illustrations of such further sound has been omitted so as to not obscure the illustration with unnecessary detail.

The external sound source 20 generates the external sound 21 in the cabinet exterior. The external sound source 20 may for example be a user of the audio device, and the external sound 21 may for example be a voice command intended to activate a function of the audio device. However, the invention is not limited to such external sound and external sound sources.

In this example, sound content of the external sound 21 relatively to sound content of the first open back driver 6a and the second open back driver 6b is larger in the input microphone signal than in the reference microphone signal. This occurs since the reference microphone 10 is primarily acoustically coupled to the cabinet interior 4, whereas the input microphone is primarily acoustically coupled to the cabinet exterior 5.

FIGS. 4 and 5 illustrate a particular example of drivers, but note that the explained principles may apply do any embodiments of the invention.

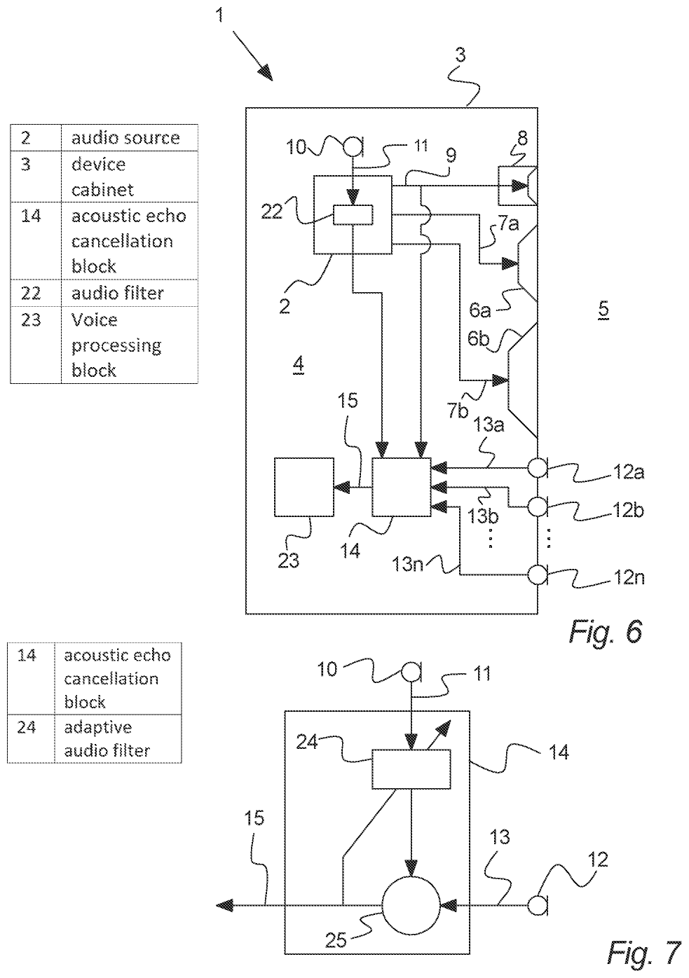

FIG. 6 illustrates another embodiment of the invention. In addition to features illustrated in embodiments of previous figures, this embodiment has several input microphones 12a, 12b, . . . 12n, a voice processing block 23, and an audio filter 22.

Further, in this embodiment, the audio source 2 is a digital signal processor. It provides the closed driver input 9, the first open driver input 7a, and the second open driver input 7b.

The audio filter 22 is a FIR filter implemented to compensate for interior reflections of the open back drivers 6a, 6b. It, thus, processes the reference microphone signal according to an acoustic prediction model.

In this particular embodiment, the audio filter 22 has been implemented in the digital signal processor instead of implementing it is a separate unit. Thus, the processing power of the digital signal processor can be utilized, and the number of components can be reduced. After the filter 22 has been applied to the reference microphone signal 11, the resulting filtered signal is provided to the acoustic echo cancellation block 14.

By using a set of input microphones 12a, 12b, . . . 12n (in contrast to using a single input microphone), it may be possible to process the set of input microphone signals 13a, 13b, . . . 13n to derive an approximate directionality of an external sound source. Such processing may enable improved extraction of voice input from ambient noise or reflections of exterior driver sounds from the external environment by filtering non-directional sound, since ambient noise and external reflected sound typically have a more uniform angular distribution than a voice input. Such processing can for example be performed before or after the acoustic echo cancellation block 14. In the particular embodiment of FIG. 6, each signal of the set of microphone signals 13a, 13b, . . . 13n are processed individually in the acoustic echo cancellation block 14. The resulting outputs are then passed individually to the voice processing block 23 (which is illustrated as a single echo-cancelled output 15).

In the voice processing block 23, the echo-cancelled output 15 is processed to identify a voice command is present. If a voice command is identified, a corresponding function of the audio device 1 is activated.

FIG. 7 illustrates an exemplary acoustic echo cancellation block 14. In this particular example, the acoustic echo cancellation block 14 receives a single reference signal from a reference microphone 11 and a single input signal 13 from a single input microphone 12. However, note that embodiments of the invention are not restricted to such examples of acoustic echo cancellation blocks (see e.g., FIGS. 2 and 6).

The illustrated acoustic echo cancellation block 14 comprises a subtraction component 25 and an adaptive audio filter 24. The reference microphone signal 11 is provided to the adaptive audio filter 24, and the resulting representation of the reference microphone signal is passed to the subtraction component 25. The subtraction component subtracts the representation of the reference microphone signal from the input microphone signal, thus providing the echo-cancelled output 15.

In addition, the echo-cancelled output is used to adapt the adaptive audio filter 24. Ideally, the adaptive audio filter 24 provides a representation of the reference microphone signal which estimates the echo content of the input microphone signal 13. However, such echo content may change during use of an audio device, for example due to changes in the external environment of the audio device. Thus, the adaptive audio filter 24 is made adaptive by feeding it with the echo-cancelled signal 15 (or a representation thereof). In practice, such feedback may be implemented by minimizing the signal power of the echo-cancelled signal 15 by adaptively changing filter components of the adaptive audio filter 24.

For several reference signals (e.g. a reference microphone signal and a closed driver input), an acoustic echo cancellation block may have several adaptive audio filters, for example one for each reference signal. Similarly, an acoustic echo cancellation block may have several subtraction components 25.

The adaptive audio filter 24 and audio filter 22 illustrated in FIG. 6, as integrated in the audio source 2, may be implemented as different filters. In such embodiments, the audio filter 22 which implementing an acoustic prediction model may also be referred to as a first audio filter, and the audio filter of the acoustic echo cancellation block may be referred to as a second audio filter. In alternative embodiments, these two filters may be implemented as a single filter, for example a single adaptive audio filter which both compensate for interior reflections and dynamically minimizes signal power of the echo-cancelled signal 15.

In the following, various embodiments of the invention are presented without reference to particular figures.

Some embodiments of the invention comprise the features of the embodiment of FIG. 2 as well as a set of input microphones acoustically coupled to a cabinet exterior of said device cabinet to record said set of input microphone signals and/or different inputs to the two drivers.

Some embodiments of the invention comprise several reference microphones in the cabinet interior. These may in combination provide improved reference microphone signals, a reference microphone signals from different positions within the device interior, and/or reference microphone signals from different enclosures within the device cabinet. Different reference microphone signals may be provided to an acoustic echo cancellation block as different reference signals, or they may be summarized to a single reference signal which is then provided to the acoustic echo cancellation block to be subtracted from one or more input microphone signals.

Alternative embodiments with a closed back speaker further comprises an auxiliary reference microphone within a closed back driver enclosure of said closed back driver. As for embodiments with several reference microphones, an auxiliary reference microphone signal may be combined with another reference microphone signal to be provided to the acoustic echo cancellation block, or a reference microphone signal and an auxiliary reference microphone signal may be provided separately. By having an auxiliary reference microphone, non-linearities of a closed back driver may be compensated for by the acoustic echo cancellation block.

Some embodiments of the invention has additional processing of the set of input microphone signals and/or the reference microphone signal prior to subtraction of a representation of the reference microphone signal from a representation of the set of input microphone signals. Further processing of a closed driver input may also be performed prior to subtraction of a representation of the closed driver input from a representation of the set of input microphone signals. Examples of processing prior to subtraction is delay, filtering, combination/addition/summing of signals, and any combination thereof. For example, since content of the input microphone signal, content of the reference microphone signal, and content of the closed driver input has not travelled through the same air pathway, insertion of a delay on one or more signal lines may be advantageous to ensure improved acoustic echo cancellation. The closed driver input may for example be delayed. And/or the reference microphone signal may for example be delayed.

Generally, the reference microphone signal, the closed driver input, and/or input microphone signals do not require to be used directly by the acoustic echo cancellation block. As exemplified, signals may be subjected to delays, filters, addition, or other processing prior to the subtraction. Hence, merely a representation of the reference microphone signal, and not the reference microphone signal itself, may be used for subtraction in the acoustic echo cancellation block. And similarly, merely a representation of the closed driver input, and not the closed driver input itself, may be used for subtraction in the acoustic echo cancellation block. And merely a representation of the set of input microphone signals, and not the set of input microphone signals itself, may be used for subtraction in the acoustic echo cancellation block. Note that a representation of the set of input microphone signals do not necessarily comprise all input microphone signals of the set, but may instead relate to only one, or a subset, of the input microphone signals. A representation of a signal may for example be a delayed signal, a filtered signal, a delayed and filtered signal. Or alternatively, a representation of a signal may just be the signal itself

Further, note that the invention is not restricted to a particular number of drivers. Embodiments of the invention may for example have three open back driver, four open back drivers, five open back drivers, or more than five open back drivers. Any combination of these may be acoustically coupled to the same cabinet interior, within the scope of the claims.

Further, embodiments of the invention may comprise several closed back drivers, for example two closed back drivers, three closed back drivers, or more than three closed back drivers. Individual closed back drivers can receive individual closed driver inputs. One or more representations of one or more of these closed driver inputs may be subtracted from a representation of the set of input microphone signals. For example, within an acoustic echo cancellation block. Several closed drive inputs may be summarized prior to subtraction.

In additional, embodiments of the invention may comprise amplifiers, crossover circuits, one or more digital signal processors, filters, or any other electronic hardware. Crossover circuits may for example distribute frequency content of a master audio signal into various audio channels/audio signals for different drivers. Amplifiers may for example amplify audio signals prior to being supplied to drivers.

From the above, it is now clear that the invention relates to an audio device with acoustic echo cancellation and a method for acoustic echo cancellation. Embodiments of the invention utilize a reference microphone located in a device interior to record sound of several open back drivers, thus potentially reducing the need for multi-channel acoustic echo cancellation while improving compensation of non-linearities of the drivers.

The invention has been exemplified above with the purpose of illustration rather than limitation with reference to specific examples of methods and audio devices. Details such as a specific method and device structures have been provided in order to understand embodiments of the invention. Note that detailed descriptions of well-known systems, components, circuits, and methods have been omitted so as to not obscure the description of the invention with unnecessary details. It should be understood that the invention is not limited to the particular examples described above and a person skilled in the art can also implement the invention in other embodiments without these specific details. As such, the invention may be designed and altered in a multitude of varieties within the scope of the invention as specified in the claims.

### LIST OF REFERENCE SIGNS

1 audio device
2 audio source
3 device cabinet
4 cabinet interior
5 cabinet exterior
6, 6a, 6b open back driver
7, 7a, 7b open driver input
8 closed back driver
9 closed driver input
10 reference microphone
11 reference microphone signal
12, 12a-12n input microphone
13, 13a-13n input microphone signal
14 acoustic echo cancellation block
15 echo-cancelled output
16a, 16b exterior sound of open back driver
17a, 17b interior sound of open back driver
18 exterior sound of closed back driver
19 interior sound reflection
20 external sound source
21 external sound
22 audio filter
23 voice processing block
24 adaptive audio filter
25 subtraction component
S1-S5 method steps

1. An audio device with acoustic echo cancellation, said audio device comprising:
a device cabinet having a cabinet interior;
a first open back driver receiving a first open driver input from an audio source;
a second open back driver receiving a second open driver input from said audio source, wherein said first open back driver and said second open back driver are acoustically coupled to said cabinet interior;
a reference microphone located in said cabinet interior to record a reference microphone signal based on sound emitted within said cabinet interior by said first open back driver and said second open back driver based on said first open driver input and said second open driver input, respectively; and
an acoustic echo cancellation block subtracting a representation of said reference microphone signal from a representation of a set of input microphone signals to provide an echo-cancelled output.

2. The audio device according to claim 1, further comprising a set of input microphones acoustically coupled to a cabinet exterior of said device cabinet to record said set of input microphone signals.

3. The audio device according to claim 1, further comprising a closed back driver receiving a closed driver input from said audio source,
wherein said acoustic echo cancellation block further subtracts a representation of said closed driver input from said representation of said set of input microphone signals to provide said echo-cancelled output.

4. The audio device according to claim 3, wherein said representation of said closed driver input and said representation of said reference microphone signal are subjected to different audio processing prior to subtraction from said set of input microphone signals.

5. The audio device according to claim 3, wherein sound content of said first open driver input relative to sound content of said closed driver input is larger in said reference microphone signal than in said set of input microphone signals.

6. The audio device according to claim 3, wherein said closed driver input is different from any of said first open driver input and said second open driver input.

7. The audio device according to claim 1, wherein said first open driver input and said second open driver input are different.

8. The audio device according to claim 1, wherein said audio device is a voice enabled device.

9. The audio device according to claim 1, wherein said audio device is a conference audio device.

10. An audio device with acoustic echo cancellation, said audio device comprising:
a device cabinet having a cabinet interior;
a closed back driver receiving a closed driver input from said audio source;
an open back driver receiving an open driver input from an audio source, wherein said open back driver is acoustically coupled to said cabinet interior;
a reference microphone located in said cabinet interior to record a reference microphone signal based on sound emitted within said cabinet interior by said open back driver based on said open driver input; and
an acoustic echo cancellation block subtracting a representation of said reference microphone signal and a representation of said closed driver input from a representation of a set of input microphone signals to provide an echo-cancelled output.

11. A method for acoustic echo cancellation, said method comprising:
providing a first open driver input to a first open back driver of an audio device to simultaneously emit sound within a cabinet interior and to a cabinet exterior of a device cabinet of said audio device;
providing a second open driver input to a second open back driver of said audio device to simultaneously emit sound within said cabinet interior and said cabinet exterior;
recording a set of input microphone signals using a set of input microphones acoustically coupled to said cabinet exterior;
recording a reference microphone signal using a reference microphone located in said cabinet interior; and
subtracting a representation of said reference microphone signal from a representation of said set of input microphone signals to provide an echo-cancelled output.

12. The method according to claim 11, wherein said representation of said reference microphone signal is based on processing said reference microphone signal according to an acoustic prediction model.

13. The method according to claim 12, wherein said acoustic prediction model at least partly compensate acoustic properties at a position of said reference microphone in said cabinet interior.

14. The method according to claim 13, wherein said acoustic prediction model is implemented as an audio filter.

15. The method according to claim 14, wherein said audio filter is implemented in a digital signal processor, and
wherein said digital signal processor additionally supplies said first open driver input and said second open driver input to said first open driver and said second open driver, respectively.

16. The method according to claim 11, wherein said audio device is subjected to external sound from a sound source in said device exterior, and
wherein sound content of said external sound relatively to sound content of said first open back driver and said second open back driver is larger in said set of input microphone signals than in said reference microphone signal.

17. The method according to claim 11, wherein said audio device is subjected to external sound from a sound source in said device exterior, and
wherein sound content of said external sound relatively to sound content of said first open back driver and said second open back driver is larger in said echo-cancelled output than in said set of input microphone signals.

18. The method according to claim 11, further comprising processing said echo-cancelled output to activate a function of said audio device.

19. The method according to claim 11, further comprising telecommunicating said echo-cancelled output.
